(19) United States
(12) Patent Application Publication
(10) Pub. No.: US 2018/0254066 A1
(43) Pub. Date: Sep. 6, 2018

(54) METHODS AND SYSTEMS FOR RECORDING, PRODUCING AND TRANSMITTING VIDEO AND AUDIO CONTENT

(71) Applicant: NEXVIDEA INC., Spring, TX (US)

(72) Inventor: Lloyd John ELDER, Edmonton (CA)

(21) Appl. No.: 15/969,206

(22) Filed: May 2, 2018

Related U.S. Application Data
(63) Continuation of application No. PCT/US2016/061182, filed on Nov. 9, 2016.
(60) Provisional application No. 62/252,824, filed on Nov. 9, 2015.
(60) Provisional application No. 62/280,484, filed on Jan. 19, 2016.

(51) Int. Cl. G11B 27/031; H04N 5/225; H04N 5/265; H04N 5/77; H04N 5/232

(52) U.S. Cl. CPC G11B 27/031; H04N 5/2258; H04N 5/23216; H04N 5/772; H04N 5/265

(57) ABSTRACT

A portable multi-view system and method for combining multiple audio and video streams is provided. The system comprises one or more adjustable arms attached to a base station, each of the one or more arms comprising one or more sensors, including a first camera transmitting a first video signal and a second camera transmitting a second video signal. The system further comprises a signal processor communicatively coupled to the one or more sensors for receiving, viewing, editing, and transmitting signals from the one or more sensors, including the first video signal and the second video signal, and an image processing module residing in a memory, communicatively coupled to the signal processor, with instructions for combining the signals received from the one or more sensors, including the first and second video signals, and sharing the combined streams according to real-time user input

### CROSS-REFERENCE

This application is a continuation application of International Application No. PCT/US2016/061182, filed Nov. 9, 2016, which claims the benefit of U.S. Provisional Application No. 62/252,824, filed Nov. 9, 2015, and U.S. Provisional Application No. 62/280,484, filed Jan. 19, 2016, which applications are entirely incorporated herein by reference.

### BACKGROUND

Remote communication via video has become an important tool in business, education, healthcare and entertainment, as well as in social and familial contexts. This type of communication can occur via an integration of a wide array of real-time, enterprise, and communication services (e.g., instant messaging, voice, including IP telephony, audio, web & video conferencing, fixed-mobile convergence, desktop sharing, data sharing including web connected electronic interactive whiteboards) and non-real-time communication services (e.g., unified messaging, including integrated voicemail, e-mail, SMS and fax). In practice, one-to-one remote communications are commonly carried out with each participant having a computing device (e.g., laptop, desktop, tablet, mobile device, PDA, etc.) that comprises a fixed camera and a microphone by which to transmit audio and video, and a screen and speaker by which to receive audio and video from the other side. Similarly, in one-to-many remote communications, such as presentations on streaming services (e.g., YouTube®, Facebook®, etc.), the content is often created, or recorded, using fixed sensors such as a camera and a microphone.

A common problem arises when a communicator or presenter desires to communicate via multiple simultaneous audio or video streams to his or her audience, such as adding a different perspective to the images or video already being transferred. In such cases, the presenter must obtain further sensors, such as cameras and microphones, audio inputs, or video inputs, to separately connect to the communication stream, and often times, additional personnel to handle recording and transmitting of the additional audio or video stream. There is therefore a need for a cost-effective and compact system that allows users to independently and conveniently record, produce, and transmit one or more simultaneous audio and video content streams.

### SUMMARY

Recognized herein is the need for a cost-effective and compact system that allows users to independently and conveniently record, produce, and transmit one or more simultaneous audio and video content streams.

The present disclosure provides a portable multi-view system for combining audio and video streams, comprising one or more adjustable arms attached to a base station, each of the one or more arms comprising one or more sensors, including a first camera transmitting a first video signal and a second camera transmitting a second video signal, a signal processor communicatively coupled to the one or more sensors for receiving, viewing, editing, and transmitting signals from the one or more sensors, including the first video signal and the second video signal, and an image processing module residing in a memory, communicatively coupled to the signal processor, with instructions for combining the signals received from the one or more sensors, including the first and second video signals, and sharing the combined streams according to real-time user input.

The system may further comprise one or more displays, one or more memory storage, or one or more online streaming services communicatively coupled to the signal processor from which a user may select to share one or more combined streams. The one or more displays may include a display of a computing device through which a user is capable of providing real-time user input to the signal processor at the same time the one or more combined streams are received and displayed by the computing device.

The system may further comprise one or more displays, one or more memory storage, or one or more online streaming services communicatively coupled to the signal processor from which a user may select to share the one or more individual signals received from the one or more sensors. The one or more displays may include a display of a computing device through which a user is capable of providing real-time user input to the signal processor at the same time the one or more individual signals are received and displayed by the computing device.

The signal processor may further receive one or more signals from one or more external sensors or one or more memory storage communicatively coupled to the signal processor.

The image processing module may further contain instructions for combining the signals according to pre-programmed editing instructions. The image processing module may further contain instructions for combining the signals according to both real-time user input and pre-programmed editing instructions. The pre-programmed editing instructions can be capable of being triggered by user input.

The present disclosure further provides a method for combining and sharing audio and video streams, comprising receiving simultaneously one or more video and audio input signals, receiving real-time user input, combining the simultaneous signals into one or more combined streams following either or both pre-programmed editing instructions and real-time user input, and transmitting the one or more combined streams to one or more memory storage, one or more displays, or one or more online streaming services.

The video and audio input signals may be received from one or more sensors or one or more memory storage.

The one or more displays may include a display of a computing device through which a user is capable of providing real-time user input at the same time the one or more combined streams are received and displayed by the computing device.

The method may further comprise transmitting individually the one or more video and audio input signals to one or more memory storage, one or more displays, or one or more online streaming services. The one or more displays may include a display of a computing device through which a user is capable of providing the real-time user input at the same time the one or more individual video and audio input signals are received and displayed by the computing device. The user may select which of the one or more individual video and audio input signals and the one or more combined streams to transmit to which of the one or more memory storage, one or more displays, or one or more online streaming services.

The pre-programming instructions can be triggered by real-time user input.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows a perspective view of one embodiment of a base station in a closed position.

FIG. 2 shows a top view of one embodiment of the base station in a closed position.

FIG. 3 shows a front view of one embodiment of the base station in a closed position.

FIG. 4 shows a perspective view of one embodiment of the base station in an open and arms-closed position.

FIG. 5 shows a front view of one embodiment of the base station in an open and arms-closed position.

FIG. 6 shows a front view of one embodiment of the base station in an open and arms-detached position.

FIG. 7 shows a perspective view of one embodiment of the base station in an open and arms-extended position.

FIG. 8 shows a cross-sectional front view and top view of one embodiment of the base station in an open and arms-closed position.

FIG. 9 shows a cross-sectional top view of one embodiment of the base station in an open and arms-closed position.

FIG. 10 shows a cross-sectional top view of one embodiment of the base station in an open and arms-detached position.

FIG. 11 shows a front view of one embodiment of a sensor head on an arm.

FIG. 12 shows a side view of one embodiment of a sensor head on an arm.

FIG. 13 shows a perspective view of one embodiment of the base station connected to a mobile device docking base.

FIG. 14 shows a perspective view of one embodiment of the base station connected to a mobile device docking base, supporting a mobile device thereon.

FIGS. 15a-c shows a simplified front view of one embodiment of the base station with a docking arm in an (a) open, (b) folded, and (c) closed position.

FIG. 16 shows a top view of one embodiment of the base station with an open docking arm.

FIG. 17 shows a front view of one embodiment of the base station with an open docking arm supporting multiple docking adapters.

FIG. 18 shows a perspective view of one embodiment of the base station with a docking port.

FIG. 19 shows a perspective view of one embodiment of the base station with a docking port, a mobile device docked thereon.

FIG. 20 shows a computer control system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

A portable multi-view system is provided for combining and sharing multiple audio and video streams. The system may allow a user to simultaneously present videos of multiple perspectives. The system may contain one or more adjustable arms, each containing a sensor, such as a camera, attached to a base station. By moving the adjustable arms, which can have a degree of rigidity, a user may flexibly adjust the position and orientation of each of the sensors, such as a camera, relative to the other sensors and/or relative to the base station. For example, a user may record a single object from multiple angles such as from the top and from the side simultaneously. The system may further allow a user to conveniently live-edit and stream the multiple video and audio streams. The user may provide real-time instructions on how to combine the multiple streams and control various editing effects during the process. The user may further select one or more displays, or memory storage, or online streaming services with which to share the one or more combined, or otherwise edited, video streams. Alternatively, the system may follow pre-programmed instructions and combine multiple video and audio streams according to default programs without having to receive real-time user instructions.

In an aspect a portable multi-view system for combining audio and video streams is provided. The system may comprise one or more adjustable arms attached to a base station, each of the one or more arms comprising one or more sensors, including a first camera transmitting a first video signal and a second camera transmitting a second video signal, a signal processor communicatively coupled to the one or more sensors for receiving, viewing, editing, and transmitting signals from the one or more sensors, including the first video signal and the second video signal, and an image processing module residing in a memory, communicatively coupled to the signal processor, with instructions for combining the signals received from the one or more sensors, including the first and second video signals, according to real-time user input.

In an aspect, the present disclosure provides a method for combining and sharing audio and video streams, comprising receiving simultaneously one or more video and audio input signals, receiving real-time user input, combining the simultaneous signals into one or more edited streams following pre-programmed editing instructions or in response to said real-time user input, and transmitting the one or more edited streams to a memory storage or one or more displays.

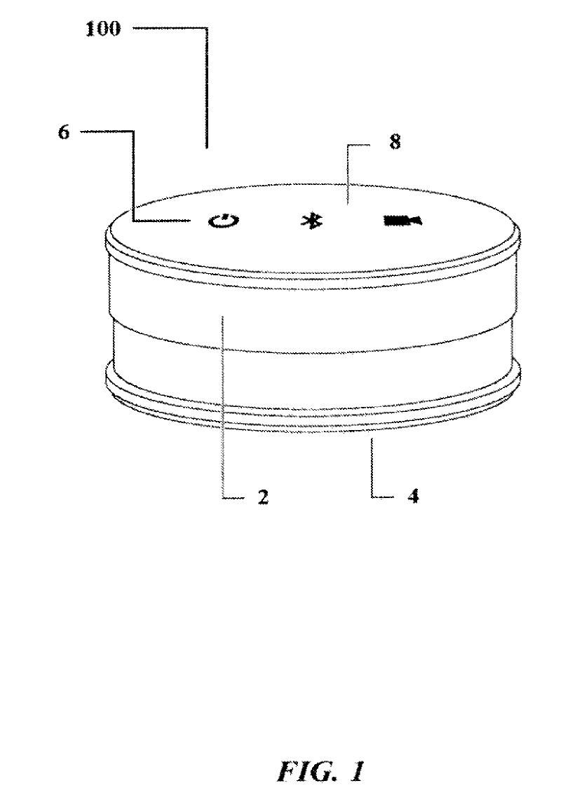

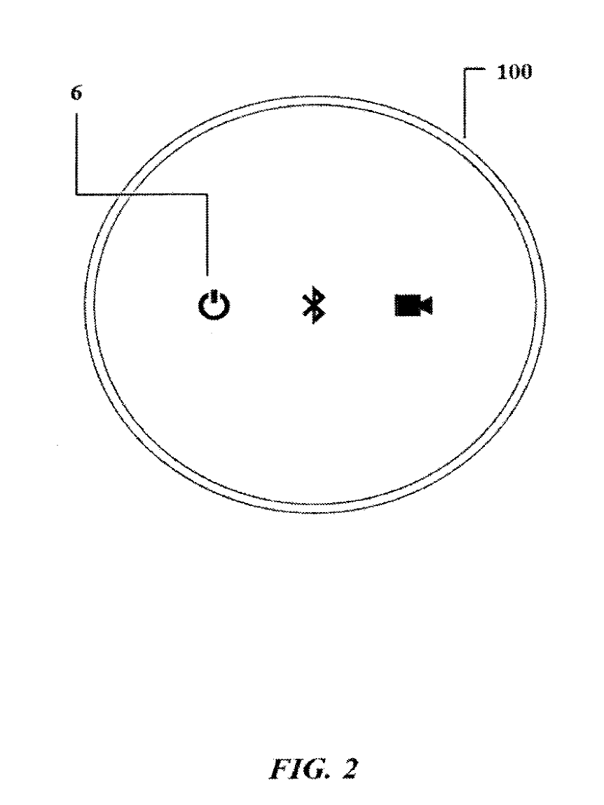

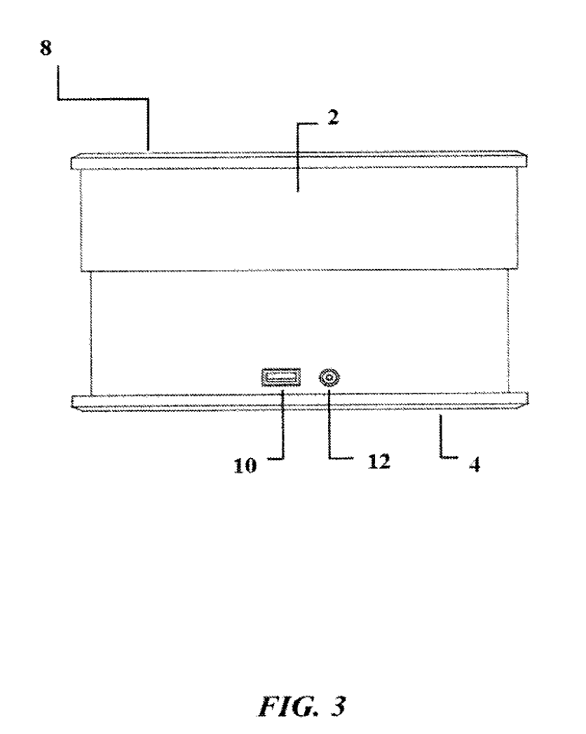

A multi-view system may comprise a base station capable of communicating with an external computing device. The base station may have an open and a closed position. FIGS. 1-3 show various views of a base station in a closed position, in accordance with embodiments of the invention. FIG. 1 shows a perspective view, FIG. 2 shows a top view, and FIG. 3 shows a front view.

The base station 100 can be compact and mobile. For example, the base station may have a largest dimension (e.g., a diameter, length, width, height, or diagonal) that is less than about 1 inch, 2 inches, 3 inches, 4 inches, 6 inches, 8 inches, 10 inches, or 12 inches. The base station may weigh less than about 15 kg, 12 kg, 10 kg, 8 kg, 6 kg. 5 kg, 4 kg, 3 kg, 2 kg, 1 kg, 500 g, 250 g, 100 g, 50 g, 20 g, 10 g, 5 g, or 1 g. The base station may be capable of being carried within a single human hand. The base station may be configured to be a handheld device. The base station may have any shape. For example, the base station may have a circular cross-section. Alternatively, the base station may have a triangular, quadrilateral, hexagonal, or any other type of shaped cross-section.

The base station may be constructed with water resistant or shock resistant material. In one example, the base station may comprise a casing. The casing may enclose one or more internal components of the base station, such as one or more processors. The casing may be made with Computer Network Controlled (“CNC”) high density foam.

The base station 100 may comprise a sliding cover 2, a base plate 4, and a top plate 8. The base plate 4 may form a bottom surface of the base station. At least an area of the base station may rest flat on an underlying surface. The base plate may contact the underlying surface. The base plate can be weighted and comprise one or more non-slip elements to ensure stable positioning on most surfaces. A top plate 8 may form a top surface of the base station. The top plate may be on an opposing side of the base station from the base plate. The top plate may be substantially parallel to the base plate. The top plate may be visually discernible while the base station is resting on an underlying surface.

A sliding cover 2 may be provided between the base plate 4 and the top plate 8. The sliding cover may have a substantially orthogonal surface relative to the base plate and/or the top plate. The sliding cover may have a degree of freedom to move about the base station 100.

A user may move the sliding cover 2 relative to the base plate 4 and/or top plate 8 to alternate the base station 100 between a closed position and an open position. The sliding cover may be moved by shifting, twisting, or sliding relative to the base station and/or top plate. The sliding cover may move in a direction substantially parallel to the longitudinal axis of the baste station between the open and closed positions. Once in either a closed position or an open position, the user may lock or unlock the sliding cover 2 in its location. The user may advantageously adjust the sliding cover to allow the base station to transform between the closed position and the open position easily with a single hand or both hands.

The base station 100 may be placed in the closed position when the system is not in use, such as during storage, charging, or travel. When in a closed position, one or more adjustable arms of the base station 100 may remain unexposed. The base station 100 may be more compact in its closed position than in its open position. For example, the interior of the casing of the base station 100 in a closed position may contain adjustable arms that are folded inside. In the closed position, the adjustable arms may be advantageously shielded from external pressures.

The base station 100 may be placed in the open position when the system is in use. When in an open position, the base station 100 may reveal one or more adjustable arms. The adjustable arms may be extended beyond the casing of the base station 100 such that the user can flexibly position one or more sensors located on the adjustable arms. The open position may further expose ports of the system that remained hidden in the closed position.

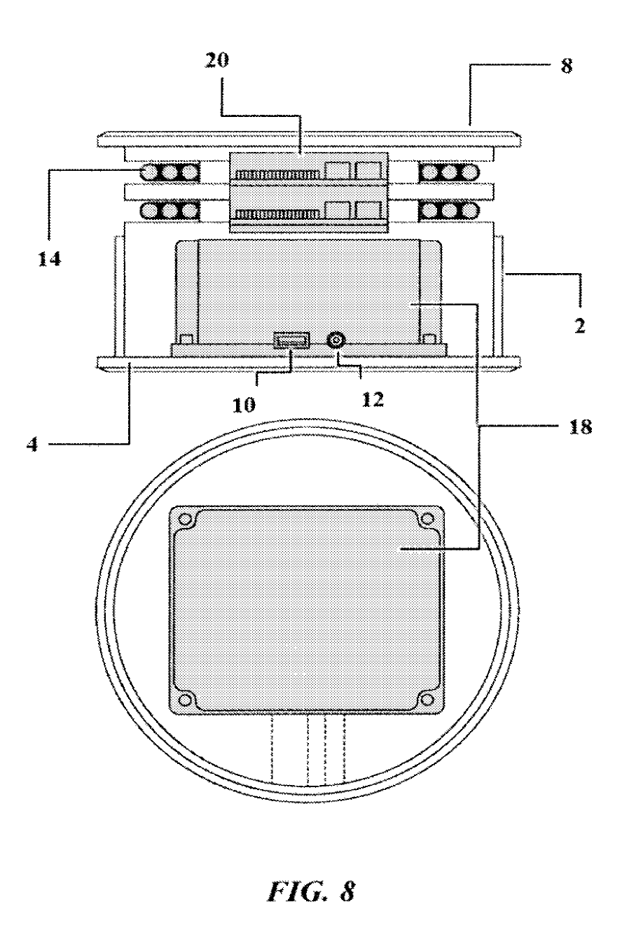

The top plate 8 may comprise one or more user input interfaces 6. In some embodiments, user input interfaces may comprise user input buttons, switches, knobs, touchscreens, levers, keys, trackballs, touchpads, or any other type of user interactive device. Any description herein of any specific type of user input interfaces, such as input buttons, may apply to any other type of user input interface. For example, input buttons may be protruded outwards or inwards from the surface of the top plate as standard buttons or be distinctly visible on the surface of the top plate as an integrated touchscreen display such as via illumination or as print. The input buttons may be communicatively coupled to a processor 20 located within the base station 100 (see also FIG. 8). Each of the input buttons 6 may trigger a distinct function of the system such as ‘system power on/off,’ ‘connect/disconnect to wireless connection (e.g., Bluetooth, WiFi),’ ‘video on/off,’ various video or audio editing functions, and accessory control.

The base station 100 may further comprise a charging port 12 for powering the system. The charging port may accept an electrical connection to an external power source (e.g., electrical outlet, computer, tablet, mobile device, external battery). Alternatively or in addition, the base station may comprise an on-board power source (e.g., local battery), and optionally may not require a charging port.

The base station 100 may comprise one or more connective ports 10 (e.g., Universal Serial Bus (“USB”), microUSB, HDMI, miniHDMI, etc.). As illustrated in FIG. 8, one or more connective ports may be coupled to a processor 20 located within the base station 100 for connecting the system with external computing devices (e.g., mobile phones, personal electronic devices, laptops, desktops, PDAs, monitors). The processor may receive real-time user input from an external computing device.

The processor 20 in the base station 100, and/or components connected to thereof, such as sensors, lighting sources, and mobile computing devices, may be powered by a rechargeable battery 18 located within the base station. The rechargeable battery can be charged through the charging port 12 via a standard 5V power source or an external DC power supply. Alternatively, the base station can be powered directly via a standard 5V power source or an external DC power supply of a different power source. The type of power supply required can be determined by power consumption of the system. Power consumption can depend on the type and number of devices connected to the processor in the base station and the type and amount of activities performed by the processor. For example, the system will require a larger power supply to power the system if the system powers multiple light sources, the processor is editing many streams of video, and the processor is also streaming video content to the internet. Alternatively, the system may be powered by a remote power supply, such as a backup battery, which can keep the system mobile and support the system for a longer duration of time than an internal battery.

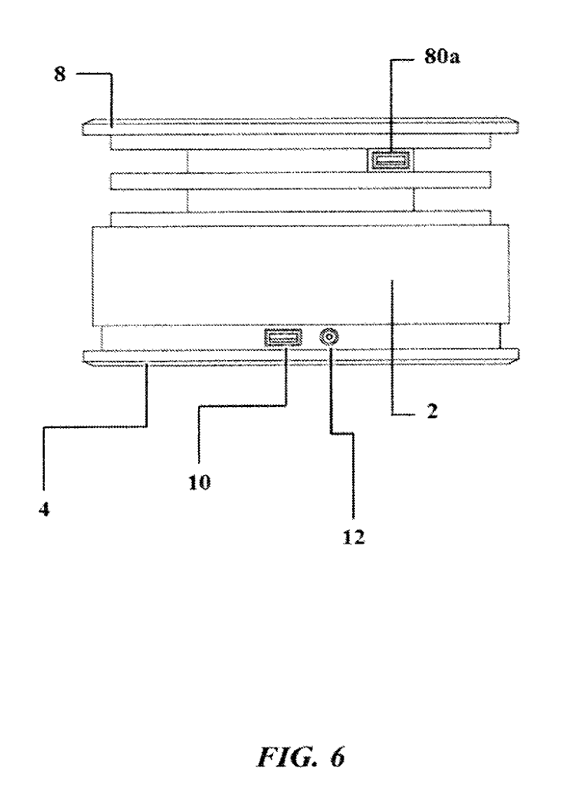

The processor 20 may comprise a processor board with one or more input and output ports, some of which are made accessible to a user via corresponding ports and openings in the base station 100, such as the connective port 10. System devices and external devices may be connected via standard or custom cables to the processor through additional connective ports or separate connective ports to the processor. System devices can include mounted or tethered sensors, integrated lighting, integrated displays, and integrated computing devices. External devices can include external computing devices (e.g., mobile phone, PDAs, laptops), external sensors, external light sources, external displays, and external video or audio sources. For example, external sensors such as aftermarket cameras (e.g., DSLRs, IP Cameras, action cameras, etc.) or aftermarket microphones may be connected to the processor via a connective port 10 or a connective port 80a (see also FIG. 6). Similarly, external video sources that are not cameras (e.g., game console, television output, or other video or still image generating device) or external audio sources that are not microphones (e.g., radio output) may be connected to the processor via a connective port 10 or a connective port 80a. Video input from external cameras or external video sources may be communicatively coupled to the processor through standard connectors (e.g., HDMI, microHDMI, SDI) or custom connectors that can require an adapter or other electronics. Video input can be digital and/or analog. Similarly, audio input from external microphones or external audio sources may be communicatively coupled to the processor through standard interfaces (e.g., XLR, 3.5 mm audio jack, Bluetooth, etc.) or custom interfaces that can require an adapter or other electronics to interface with the processor. Similarly external light sources may be communicatively coupled to the processor through standard connectors or custom connectors that can require electronics to communicate with the processor.

The system may further comprise a WiFi-card (e.g., 802.11 b/g/n/ac) and Bluetooth module coupled to the processor 20 to support wireless connections of system devices and external devices to the processor. The system may further employ other wireless technology such as near field communication (“NFC”) technology. The wireless connection may be made through a wireless network on the internet, intranet, and/or extranet, or through a Bluetooth pairing. In one example, an external computing device such as a mobile device may send real-time user input to the processor via a wireless connection. In one example, external sensors, such as aftermarket cameras or aftermarket microphones, may send video or audio signals to the processor via a wireless connection. In one example, external video or audio sources, such as television output or radio output, may send video or audio signals to the processor via a wireless connection. In one example, the processor may transmit video or audio streams to external displays, external computing devices, or online streaming services via a wireless connection. Alternatively, the processor may transmit video or audio streams to online platforms via an Ethernet cable. The system may further access, read, or write to removable storage (e.g., plug-and-play hard-drive, flash memory, CompactFlash, SD card, mini SD card, micro SD card, USB) via a memory card slot or port in the processor or remote storage (e.g., cloud-based storage) via a wireless connection to the remote storage drive.

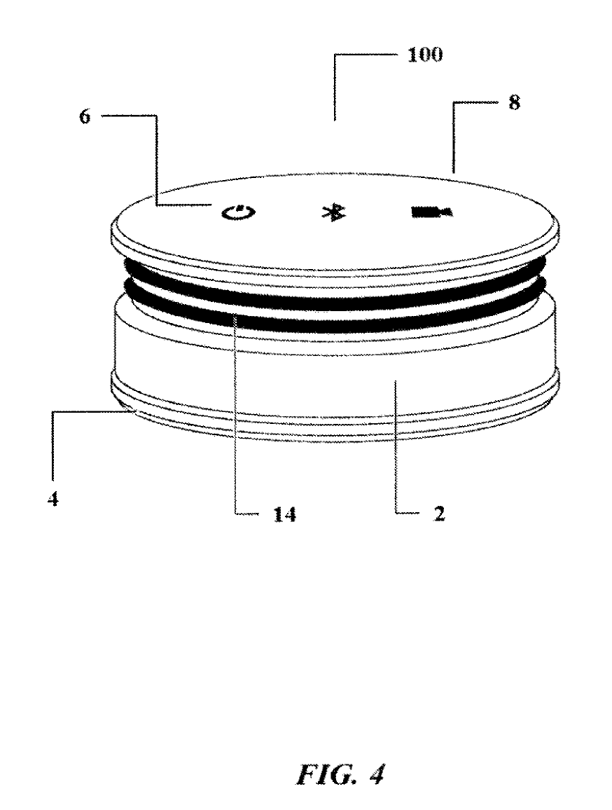

FIGS. 4-7 show different views of a base station in an open position, in accordance with embodiments of the invention. When in the open position, the base station may further have an arms-closed position, an arms-extended position, and an arms-detached position.

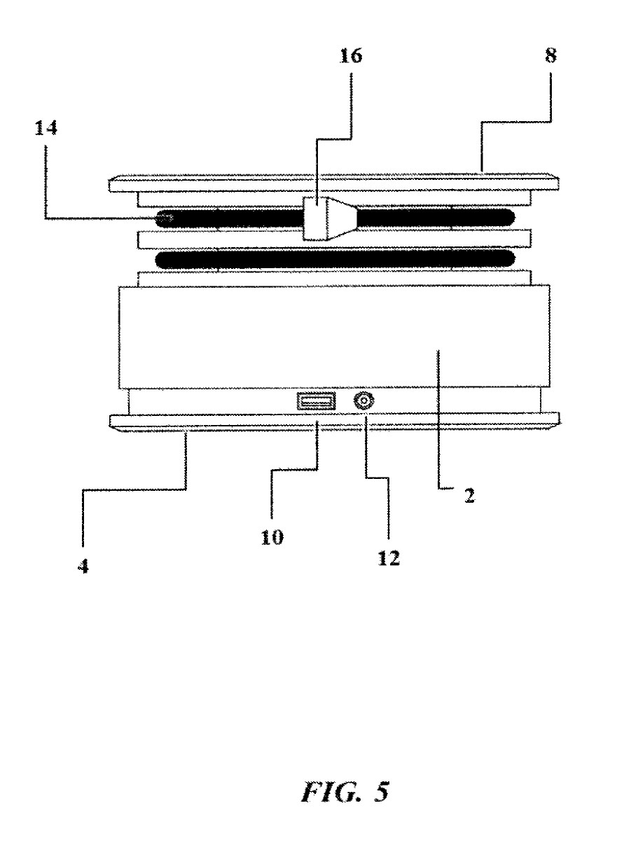

FIG. 4 shows a perspective view of the base station 100 in an arms-closed position and FIG. 5 shows a front view of the base station 100 in an arms-closed position. In an arms-closed position, one or more adjustable arms 14 may lie in a form and shape on the base station that allows a user to alternate the base station between a closed position and an open position. For example, the adjustable arms can be physically wound around a portion of the base station beneath the sliding cover 2. The base station may comprise grooves beneath the sliding cover to house or guide the winding of the adjustable arms. Alternatively, the adjustable arms can be folded inside a hollow base station.

FIG. 6 shows a front view of the base station 100 in an arms-detached position. In an arms-detached position, the adjustable arms 14 may be physically detached from the base station.

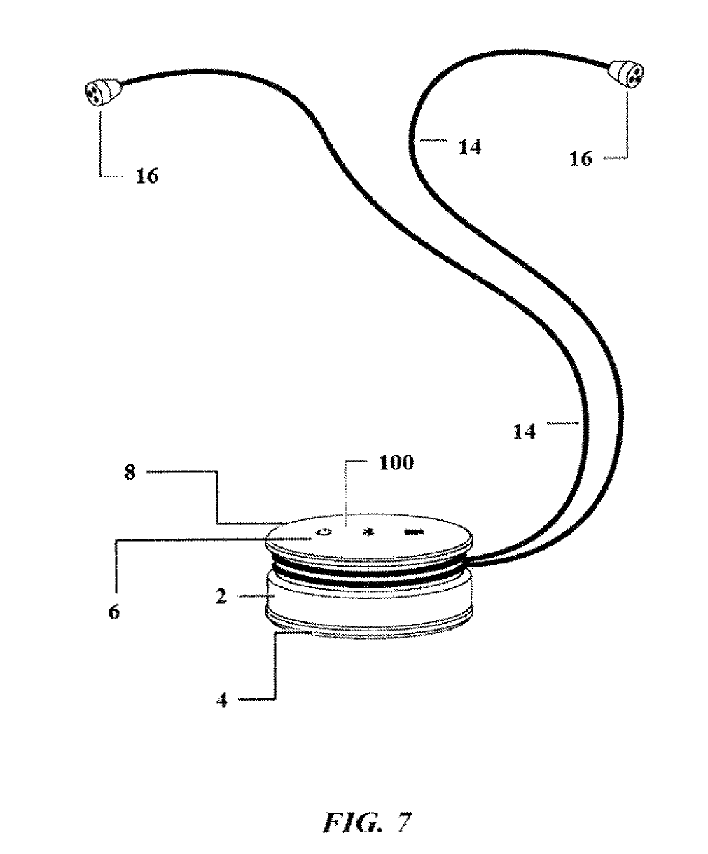

FIG. 7 shows a perspective view of the base station 100 in an arms-extended position. In an arms-extended position, the length of the adjustable arms 14 may be positioned to extend beyond the sliding cover 2 of the base station.

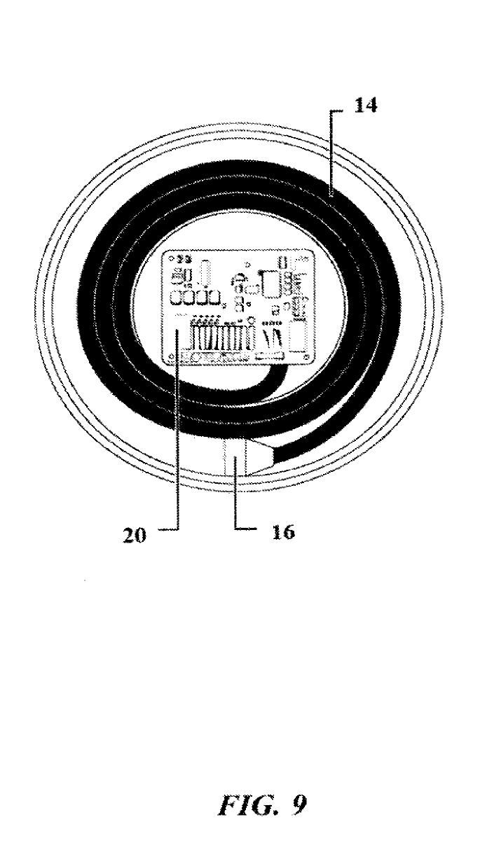

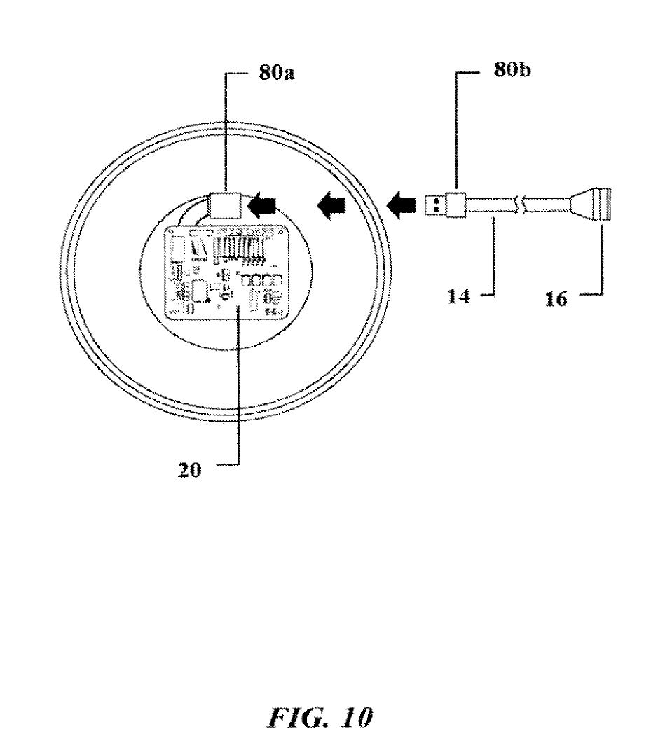

FIGS. 8-10 show different cross-sectional views of a base station in an open position, in accordance with embodiments of the invention. FIG. 8 shows a cross-sectional front view and top view of the base station 100 in an open and arms-closed position, FIG. 9 shows a cross-sectional top view of the base station 100 in an open and arms-closed position, and FIG. 10 shows a cross-sectional top view of the base station 100 in an open and arms-detached position. A user may place the base station in an open position by shifting sliding cover 2 to reveal a compartment that can house one or more adjustable arms 14. A user may still access the charging port 12 and one or more connective ports 10 of the base station in the open position. The present embodiments show a system having two adjustable arms 14. Alternatively, the system may comprise a base station of substantially the same design (e.g., with a larger diameter or height) having more than two adjustable arms. Any number of arms (e.g., two or more, three or more, four or more, five or more) may be provided.

Each of the one or more adjustable arms 14 may be permanently (as in FIG. 9), or detachably (as in FIG. 10), attached to the base station 100. A proximal end of the adjustable arm may be electrically connected to a processor and/or a power source. When permanently attached, the proximal end of the adjustable arm may be permanently affixed to the processor and/or power source. When detachably attached, the proximal end of the adjustable arm may comprise a connection interface (e.g., connection port 80a) that may allow detachable connection with a corresponding interface of the processor and/or power source (e.g., connection port 80b). The interfaces may allow for mechanical and electrical connection of the arm to the processor and/or power source. In some embodiments, each of the arms may be permanently attached, each of the arms may be detachably attached, or one or more arms may be permanently attached while one or more arms are detachably attached.

Each of the one or more adjustable arms may comprise a sensor head 16 affixed at a distal end. The sensor head may comprise one or more sensors, such as cameras and/or microphones. Each of the sensors on the sensor head can be communicatively coupled to a processor 20 located within the base station 100, such as via a wired or a wireless connection. An example of a wired connection may include one or more cables embedded within the length of the adjustable arm 14. An example of a wireless connection may include a direct wireless link via the sensor and the processor. If an adjustable arm is detachable, the adjustable arm may attach to the base station using a standard (e.g., USB-type ports) or custom connector. For example, USB-type connection ports 80a and 80b can be used to connect a detachable arm to the base station. Connection port 80a can be coupled to a processor located within the base station. Connection port 80b can be affixed to a proximal end of the adjustable arm and be communicatively coupled to the sensor head which is affixed to a distal end of the adjustable arm. Each of the sensors located on a sensor head can then communicate with the processor via the coupling of connection ports 80a and 80b. Alternatively, a user may couple connection port 80a to an external sensor, such as an aftermarket camera of the user's choice, instead of an adjustable arm. Alternatively, a user may couple an aftermarket camera wirelessly (e.g., WiFi, Bluetooth) to the processor without having to use connection port 80a.

The adjustable arms 14 may be freely positioned, rotated, tilted, or otherwise adjusted relative to the other adjustable arms 14 and/or relative to the base station 100. The adjustable arms 14 can further have a degree of rigidity to ensure that the arms 14 are flexible and fully positionable at any desired location and orientation. In an arms-closed position, each of the one or more adjustable arms 14 can lay coiled, or otherwise folded, within the base station 100. In an arms-detached position, each of the adjustable arms 14 can lay detached from the base station 100, leaving free one or more connection ports 80a. In an arms-extended position (as in FIG. 7), each of the adjustable arms 14 can be flexibly positioned such that each sensor head 16 is fixed at a desired location and orientation. The location of the sensor head may be controlled with respect to one, two, or three axes, and the orientation of the sensor head may be controlled with respect to one, two, or three axes. For example, with two adjustable arms 14, a user may fix a first camera and a first microphone at a first desired position and orientation and fix a second camera and a second microphone at a second desired position and orientation. The user may control the sensor positions by manually manipulating the adjustable arms. The arms may be deformed or reconfigured in response to force exerted by the user. When the user stops applying force, they may remain in the position at which they were when the user stopped exerting force.

With the flexibility of the adjustable arms, a user may capture images or video of an object from different perspectives simultaneously. For example, the different perspectives may be of different angles. For example, the different perspectives may be of different lateral position and/or vertical height. For example, the different perspectives may be of a zoomed out view and a zoomed in view relative to the other. For example, the system may be used to record the video of a person doing a demonstration involving his or her hand. In this example, the system may simultaneously record with one camera the person's face and with another camera the person's hand.

Alternatively, in another embodiment, the system may comprise one fixed arm and one or more adjustable arms 14. The fixed arm can have a proximal end attached to the base station 100 and a sensor head 16 affixed to a distal end. The fixed arm may not be adjusted relative to the base station. In this configuration, the user can move the whole of the base station in order to position and orient a sensor, such as a camera, on the fixed arm. The user may freely and flexibly adjust the location and orientation of the other adjustable arms relative to the fixed arm and/or the base station. Alternatively, in another embodiment, the system may comprise one fixed arm and no adjustable arms. External sensors, such as aftermarket cameras or aftermarket microphones, can be communicatively coupled to the processor 20 in the base station and be moved according to the freedom of the particular external sensor. Alternatively, in another embodiment, the system may comprise only of one or more fixed arms, each fixed arm pre-positioned for the user.

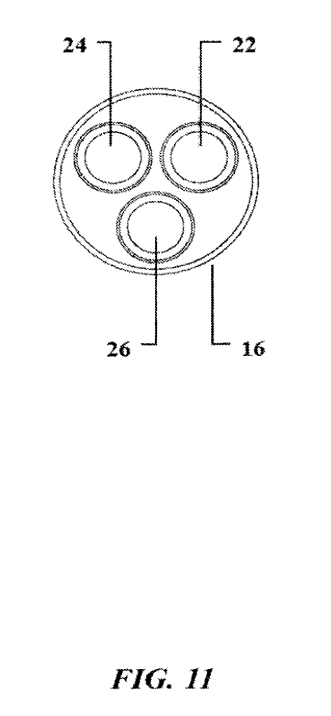

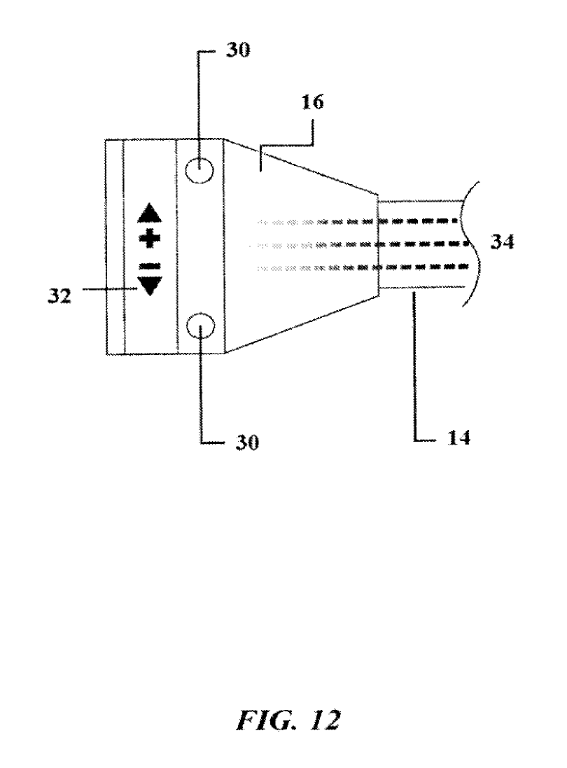

FIG. 11 and FIG. 12 show different views of a sensor head 16 in accordance with embodiments of the invention. FIG. 11 shows a front view and FIG. 12 shows a side view. Each sensor head 16 may comprise one or more sensors that are each communicatively coupled to the processor 20. For example, a sensor head may comprise a camera 22 and a microphone 24. The sensor head may further comprise a light source 26 that is communicatively coupled to the processor 20. Other types of sensors that could be present on the sensor head include light sensors, heat sensors, gesture sensors, and touch sensors. Each sensor head of each of the adjustable arms may have the same type of sensors, or one or more of the sensor heads may have different types of sensors. For example, a first arm may have a sensor head with a camera and a microphone while a second arm may have a sensor head with only a camera. Any of the sensors on the sensor head may be modular and may be swapped for one another or upgraded to a new model. For example, a microphone may be swapped out for a light source. In another example, the camera on the sensor head can be modular and can be easily substituted with or upgraded to a different type of camera. Further, the camera may accept different accessories, such as lighting, microphone, teleprompter, and lenses (e.g., wide angle, narrow, or adjustable zoom).

The camera 22 may have a field of view and pixel density that allow for a cropped portion of the image to still meet a minimum resolution standard, such as 1080p or 780p. Such minimum resolution can allow a user to pursue various editing effects, including rotation of the video, following a subject, digital zoom, and panning. The camera may have a fixed focal length lensing or auto-focused lensing. The camera may have a fixed field of view or an adjustable field of view. Each of the cameras on different sensor heads may have either the same or different configurations of focal length or field of view. The cameras may allow for optical and/or digital zoom.

The microphone 24 can record mono audio from a fixed location or record stereo audio in conjunction with other microphones located on different adjustable arms. Alternatively, the system may have an array of microphones integrated in the base station 100, communicatively coupled to the processor 20, to allow for 360-degree audio capture. Alternatively, the system may comprise a combination of microphones located on adjustable arms and an array of microphones integrated in the base station. The system may comprise multiple audio recording technologies, such as digital, analog, condenser, dynamic, microelectricalmechanical (“MEMS”), and ribbon.

The system can have integrated lighting such as the light source 26 to improve video or image quality, for example, in low light environments or to improve the appearance of the subject of the video or image. The light source can be in multiple configurations, such as a grid of some shape (e.g., circular, triangular) or a ring or perimeter of lights around a shape. For example, a ring of lights may be provided around a circumference of a sensor head 16. On the sensor head, the light source 26 can be positioned as in center, off center, or off angle relative to the camera 22 on the same sensor head. The position of the light source relative to the camera may be changed by rotating the sensor head. Alternatively, a second light source from a second adjustable arm 14 and second sensor head may be used to support a first camera on a first adjustable arm and first sensor head. In this configuration, the second light source may be flexibly adjusted relative to the first camera by adjusting the first and second adjustable arms. The light source can be capable of powering on and off, dimming, changing color, strobing, pulsating, adjusting a segment of the lighting, or any combination of the above.

The sensor head 16 may further comprise select adjustment controls 30, 32 that a user can adjust to change one or more variables for each, or some, of the sensors and light source 26 on the sensor head 16. For example, for a camera 22, the sensor head may comprise adjustment controls such as a power on/off control, zoom in/out control 32, and auto-focus on/off control 30. For example, for a microphone 24, the sensor head may comprise adjustment controls such as a power on/off control, volume control, pitch control, audio leveling or balancing control, and a mono or stereo audio toggle. The sensor head may further comprise adjustment controls for the light source 26. For example, for the light source, the sensor head may have a power on/off control, brightness control, or color control among other light source variables. The adjustment controls 30, 32 may be in the form of switches, dials, touch-sensitive buttons, or mechanical buttons, among many other possibilities. A user may adjust sensor variables or light source variables by either manually adjusting the adjustment controls present on the sensor head or through remote management 34, or through a combination of both. Remote management may allow a user to use a remote device to transmit instructions to the processor 20 to adjust various sensor variables. These instructions may be sent through a software on an external computing device (e.g., mobile phone, tablet, etc.) that is communicatively coupled to a processor located in the base station. Alternatively, the adjustment controls may also be presented to a user as input buttons 6 on the base station, which can be mechanical buttons or an integrated touchscreen display. For example, a “video on/off” button on the base station may be programmed to power on or off simultaneously both the camera and the microphone. Alternatively, the processor may receive from a memory pre-programmed instructions to trigger sensor or light source adjustments, without user instructions, as automatic responses to certain editing sequences or sensor recognition.

A processor 20 located within the base station 100 may be communicatively coupled to an external computing device, from which the processor can receive real-time user input, including instructions to adjust sensor variables and instructions on how to combine the signals received from the sensors (e.g., audio and video signals). The external computing device may be mounted, tethered, or otherwise docked onto the base station or connected wirelessly (e.g., Bluetooth, WiFi) to the processor in various embodiments.

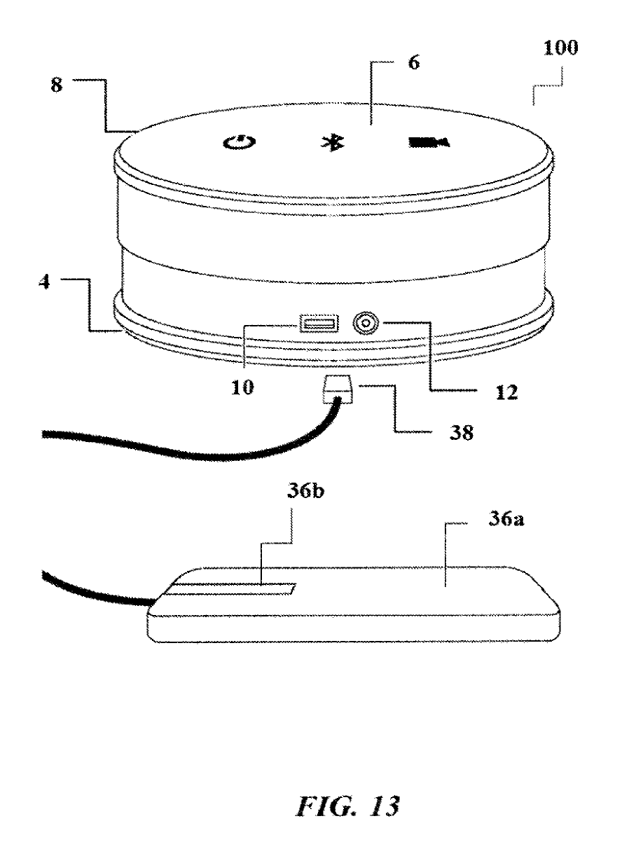

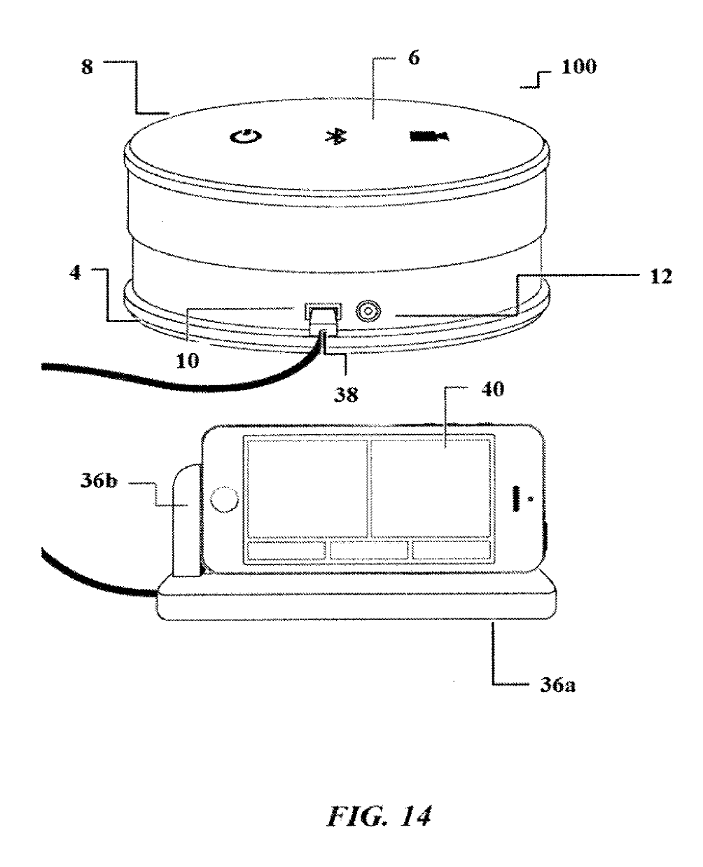

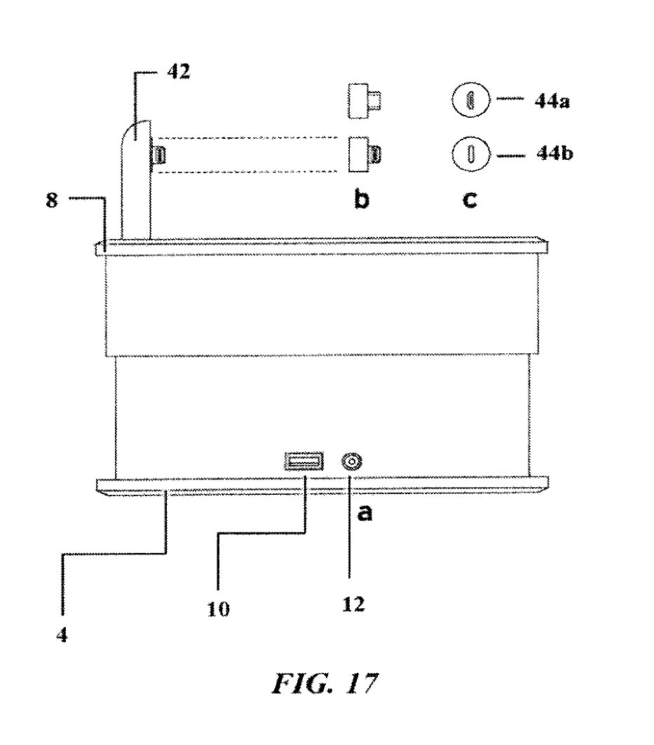

FIGS. 13-19 show different embodiments of the base station 100 allowing the docking of an external computing device. FIGS. 13-14 show an example of a base station coupled to a mobile device docking base. FIG. 13 shows a perspective view of the base station with the mobile device docking base and FIG. 14 shows the same, supporting a mobile device thereon. The mobile device docking base may be provided external to a casing of the base station. The mobile device docking base may be detachably coupled to the base station. A mobile device docking base 36a can be connected to the base station 100 via port 10 and connector 38. The mobile device docking base may be connected to the base station via a flexible or rigid connector. The mobile device docking base may be capable of coupling to an external computing device, such as a mobile device. Any description herein of a mobile device may apply to other types of external computing devices. The mobile device docking base may be configured mechanically and/or electrically couple with the mobile device. In one example, the mobile device docking base 36a can have a hinged docking arm 36b which can be communicatively coupled to a mobile device 40. The docking arm may open in a vertical position when supporting a mobile device, as in FIG. 14. Alternatively, the base station may contain a wireless card that allows for a wireless connection between the processor 20 and the mobile device docking base, or between the mobile device and the processor. The docking arm may be capable of connecting with one or more docking adapters, as in the detachable and interchangeable mobile device adapters 44a and 44b (illustrated in FIG. 17). Multiple docking adapters of different types or configurations may be capable of attaching to the docking arm in sequence or simultaneously. The docking arm may comprise detachable and interchangeable mobile device adapters 44a and 44b to support any number of mobile devices having different types of connector ports (e.g., microUSB, lightning ports).

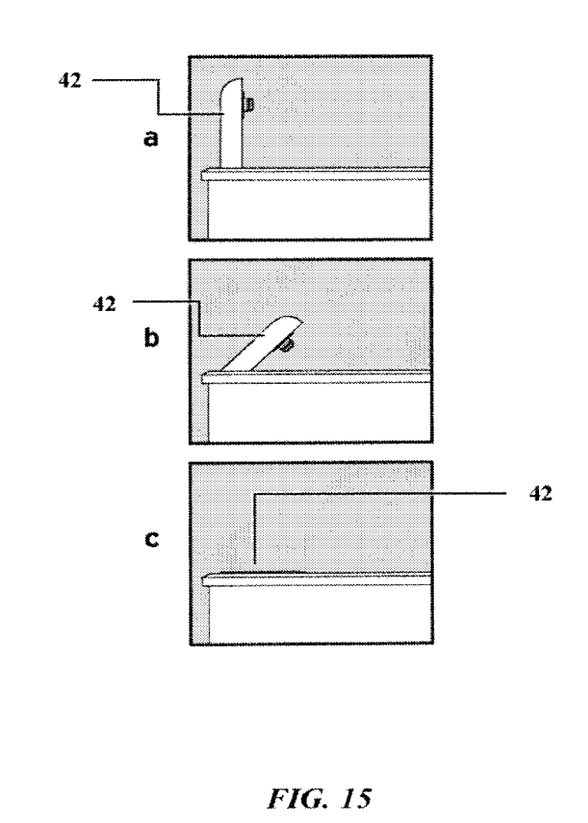

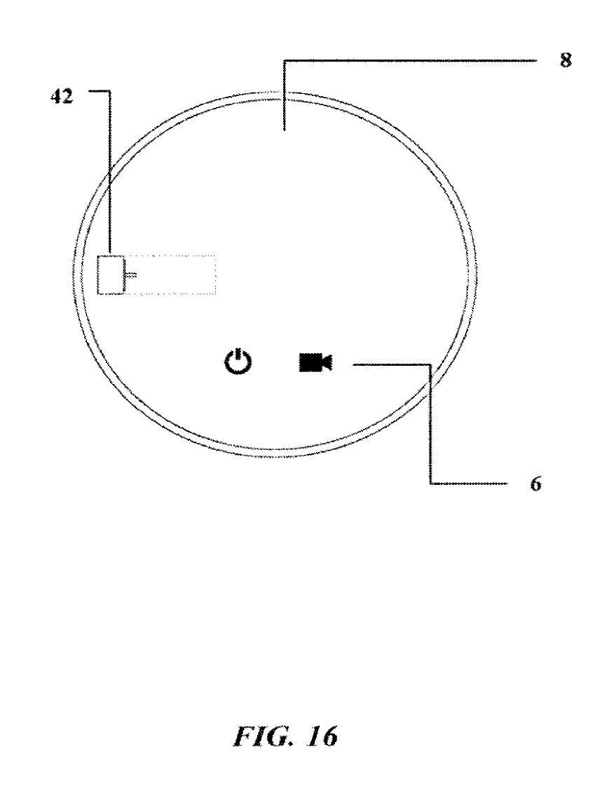

FIGS. 15-17 show an example of a base station 100 having an on-board docking mechanism. The on-board docking mechanism may be a hinged docking arm. FIGS. 15a-c show a simplified front view of the docking arm in an (a) open, (b) folded, and (c) closed position. FIG. 16 shows a top view of the base station 100 with an open docking arm. FIG. 17 shows a front view of the base station 100 with an open docking arm. The base station may comprise a hinged docking arm 42 protruding vertically from the top plate 8. When not in use, the docking arm can be folded into the same level as, or below, the surface of the top plat. A mobile device 40 may be docked onto the docking arm when the docking arm is in an open position, as in FIG. 15(a). When the docking arm is in a closed position, it may fold out of sight from a front view of the base station, as in FIG. 15(c). Via detachable and interchangeable mobile device adapters such as adapters 44a or 44b, the docking arm may support any number of mobile devices having different connector ports (e.g., microUSB, lightning ports), as illustrated in FIG. 17. Once a mobile device is docked onto an open docking arm, the connecting adapter 44a or 44b may rotate around an axis parallel to the surface plane of the top plate 8 and in the direction of the docking arm's folding path, thus rotating the docked mobile device with it to different landscape viewing angles.

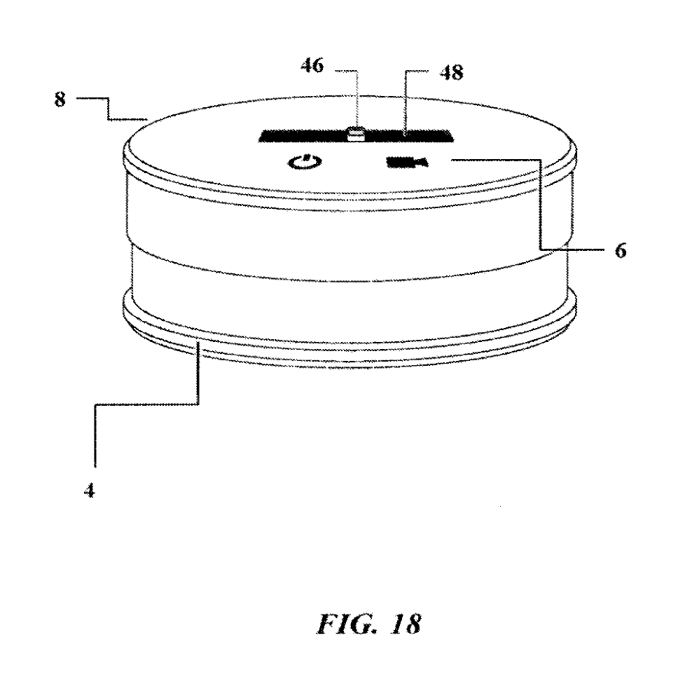

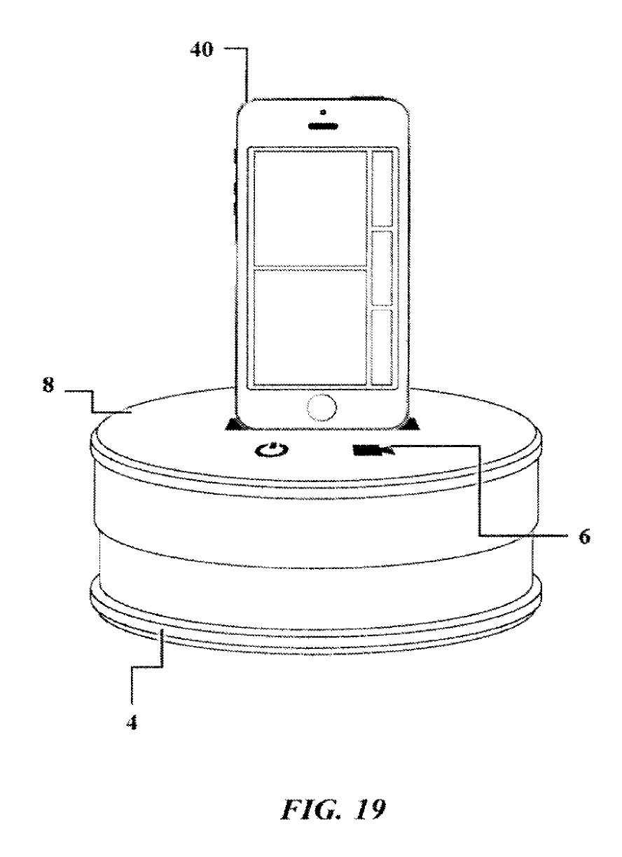

FIGS. 18-19 show another example of a base station with an on-board docking mechanism. FIG. 18 shows a perspective view of one embodiment of the base station with a docking port and FIG. 19 shows the same, supporting a mobile device thereon. The base station 100 may comprise a docking port 46 protruding vertically, or at a slight angle from the vertical axis, from the top plate 8. The docking port may or may not be movable relative to the rest of the base station. The base station may further comprise a recess 48 in the top plate 8 from which the docking port 46 protrudes. A recess 48 may help support a docked mobile device 40 in an upright manner, as in FIG. 19. Via detachable and interchangeable mobile device adapters, the docking arm may support any number of mobile devices having different connector ports (e.g., microUSB, lightning ports).

The system can permit live-editing and sharing of multiple video and audio streams. To perform these functions, the system may comprise a signal processor such as the processor 20 for receiving, viewing, editing, and transmitting audio and video signals. The processor may receive the audio and video signals from a variety of sources. The audio and video signals may be live or pre-recorded inputs. In one embodiment, the processor may receive the signals from one or more sensors 22, 24 communicatively coupled to the processor. These sensors may communicate with the processor via a cable connection embedded in the length of the adjustable arms 14. Alternatively, the sensors may communicate with the processor via a wireless connection. In one embodiment, the processor may receive the signals from one or more external sensors such as aftermarket cameras or aftermarket microphones communicatively coupled to the processor. These external sensors may communicate with the processor via a standard or custom connector or via a wireless connection. In one embodiment, the processor may receive the signals from one or more external audio or video sources that are not cameras or microphones (e.g., game console, television output, radio output) communicatively coupled to the processor. These external audio or video sources may communicate with the processor via a standard or custom connector or via a wireless connection. In one embodiment, the processor may receive the signals from one or more memory storage communicatively coupled to the processor, including plug-and-play hard-drives, flash memory (e.g., CompactFlash, SD card, mini SD card, micro SD card, USB drive), and cloud-based storage. The memory storage may communicate with the processor via memory card slots or ports in the processor or via a wireless connection such as to remote cloud-based storages. In one embodiment, the processor may receive the signals from other sources containing pre-recorded content such as pre-recorded videos, photographs, still images, overlays, or other assets. The pre-recorded content can be uploaded to the processor from memory storage or over a wireless connection. In one embodiment, the processor may receive the signals from a combination of the above sources. The processor may receive audio and video signals from the one or more sources simultaneously. The processor may treat all audio and video signals received by the processor as editable assets.

The system may comprise an image processing module residing in a memory, communicatively coupled to the signal processor, such as the processor, with instructions for combining and editing the signals received by the signal processor. The image processing module, or other software, residing in the base station 100 may be regularly updated via over-the-air protocols, such as through wireless connections to the Internet. The processor 20 may follow instructions from real-time user input or pre-programmed instructions from memory. The pre-programmed instructions may include distinct editing sequences that can be selected by a user. Alternatively, the processor may perform one or more editing sequences, without selection by a user, as an automatic response to a triggering event. The automatic responses may be pre-programmed based on time, editing, or other triggering events, or a combination of the above variables. A user selection may override pre-programmed sequences. The real-time user input or pre-programmed instructions may include editing commands, sensor adjustment commands, light source adjustment commands, display commands, and receiving or transmitting commands.

The processor 20 may receive real-time user input instructions from external computing devices (e.g., mobile device application interface, desktop application interface, remote control) which are communicatively coupled to the processor. An external computing device may communicate with the processor via cable or via wireless connection. Alternatively, the base station 100 may comprise an integrated touchscreen interface communicatively coupled to the processor allowing for user input. Alternatively, a user may send real-time instructions via dedicated command buttons 6 on the base station communicatively coupled to the processor.

A user may simultaneously record images, video, or audio of himself or herself and provide real-time instructions to the processor 20. That is, a user can be editing in real-time a video of himself or herself. Alternatively, more than one user may be involved. At least one user may be captured in an image, video, or audio, while at least one other user edits the same image, video, or audio. Real-time can include a response time of less than 1 second, tenths of a second, hundredths of a second, or a millisecond. All of the editing processes or response processes, such as those described above or further below, is capable of happening in real-time. That is, the processor may collect data and manipulate, or otherwise edit, the same data in real-time.

The image processing module can comprise instructions to stitch videos and audio signals according to real-time user input. For example, in a system receiving two video inputs and two audio inputs as a first audio stream, a second audio stream, a first video stream, and a second video stream, a user may instruct the processor 20 to associate the first audio stream with the second video stream and the second audio stream with the first video stream. The processor may receive such user input and combine the streams to generate two output streams, one combining the first audio stream with the second video stream, and one combining the second audio stream with the first audio stream. To that end, the processor may selectively combine any video stream and any audio stream received from any type of audio or video input source, including from external devices, as instructed by the user. The multiple audio and video streams may be combined using one or more editing sequences in the image processing module, including dynamically transitioning between multiple streams in multiple locations, rotation of a stream (e.g., 0 to 360 degrees), vertical tiling of streams, horizontal tiling of streams, copying a same stream in multiple locations, panning the stream, overlay, picture in picture, and any combination of the above. Alternatively, the image processing module can comprise instructions to stitch videos and audio signals according to a pre-programmed default setting in the event that there is no real-time user input, such as before a user transmits a first instruction to the processor.

In one example, the image processing module can comprise editing sequences that use editable assets such as still images, overlays, text, sound clips, and music during the combination and editing of multiple video streams. These editable assets may be used in one or more editing sequences and can be static or dynamic and positioned in a 2-D location or in depth such as in a 3-D video format. The processor 20 may receive the editable assets as an independent video source or audio source such as from a memory storage device.

In one example, the image processing module can comprise editing sequences that apply filters that affect the appearance of one or more video input streams. A user may select one or more filters to apply to one or more video streams.

In one example, the image processing module can comprise one or more editing sequences to support a 3-D perspective mode. If a user selects the 3-D mode, two camera sensors can be aligned in space via an adapter or with software guidance from an external computing device (e.g., visual guidelines in a display) to record video in a 3-D perspective. The processor 20 may then receive simultaneous video signals from the two camera sensors, specifically positioned in the 3-D mode, to combine the two video streams into a single stream in 3-D video format.

In one example, the image processing module can comprise one or more editing sequences creating a Chroma Key effect. To create a Chroma Key effect, the processor 20 can remove a single color (e.g., green) from a first video stream allowing the first video stream to have transparent sections. The processor can then combine a second video input source, image, or pattern as the background of the first video that has been processed with the Chroma Key effect. The processor may combine, in layers, multiple video inputs that have gone through Chroma Key and those that have not.

In one example, the image processing module can comprise instructions to adjust the system's sensor 22, 24 variables or light source 26 variables as part of certain editing sequences. For example, the processor 20 may control automatic audio leveling or balancing based upon a particular editing sequence. Similarly, the processor may control camera auto focus based upon a particular editing sequence. In another example, the processor may automatically synchronize the color of a lighting source (e.g., adjustable color LEDs) based on an editing sequence to achieve the best white-balance performance in the images or video being recorded by a camera.

In another example, the processor 20 may adjust a lighting source 26 based on an editing sequence to emphasize, or provide subtle cues to, the subject of a camera 22 recording the primary stream. For this editing sequence, a user may identify to the processor which camera is recording the primary stream, which the secondary stream, which the tertiary stream, and which cameras are not part of the editing sequence. Then, the processor may adjust a lighting source to, for instance, shine a light of contrasting color when the primary stream is in focus, another distinct color when a secondary or tertiary stream is in focus, and turn off the light when a camera not part of the editing sequence is in focus.

In one example, the image processing module can comprise instructions to perform one or more editing sequences based on pre-programmed reactions. As in the above example, where each camera of the system is prioritized as primary, secondary, tertiary, and so on, the processor 20 can automatically designate, or switch, the priority of the cameras based on a corresponding audio volume or duration. For example, if a first subject recorded by a first camera and a first microphone begins to talk, and a second subject recorded by a second camera and a second microphone remains silent, the processor may designate the first camera and first microphone as the primary camera and primary microphone, respectively. The processor may perform further pre-programmed editing sequences to insert overlays stating the name of the user of the primary camera after a transition of priorities that can fade away after a specified or default time (e.g., 5 seconds).

The system can share the one or more combined, or otherwise edited, video streams as video output streams to one or more displays, memory storage, online streaming services, or a combination of the above. A user may select which of the one or more displays, memory storage, or online streaming services to transmit the video output streams to and send instructions to the processor 20. In one example, the processor may transmit the video output streams to online streaming services (e.g., Facebook®, Youtube®) using encoders over the internet. The output streams may be transmitted to the internet via an Ethernet cable or via a wireless connection. The streaming encoding can match the specific requirements of the selected streaming service. In one example, the video output stream can be transmitted over a standard video encoding wire (e.g., HDMI, analog video) or a standard output, such as a USB UTV webcam format, which can allow a user to see the video output as a webcam input.

The system can share video output streams to an external computing device through which a user provides real-time user instructions. The external computing device may comprise a display. Alternatively, the system can share video output streams to an integrated interface, comprising an embedded operating system and a display, located on the base station 100 and communicatively coupled to the processor 20, through which a user can provide real-time user instructions without an external computing device. The integrated interface may comprise a touchscreen. The integrated interface may accept common computer accessories such as a mouse and a keyboard. The external computing device or integrated interface may receive and display the video output streams from the processor 20 while remaining in operable communication with the processor to transmit real-time user instructions. A user may therefore view the edited results as they are edited in real-time.

The system may transmit as video output streams a final edited video stream, or, alternatively, a specific input stream. For example, if the system has two camera input streams and three video output displays, including a first camera input stream, a second camera input stream, a first display, a second display, and a third display, the processor 20 may transmit the first camera input stream to the first display, the second camera input stream to the second display, and an edited video stream to the third display. A user may select which input stream and which edited stream will be transmitted to which display, memory storage, or online streaming services. This feature can be used for viewing and preparing live video feeds for editing, or streaming multiple video perspectives of the same event to different streaming services.

In one example, the processor 20 may transmit all edited streams to memory storage as backup.

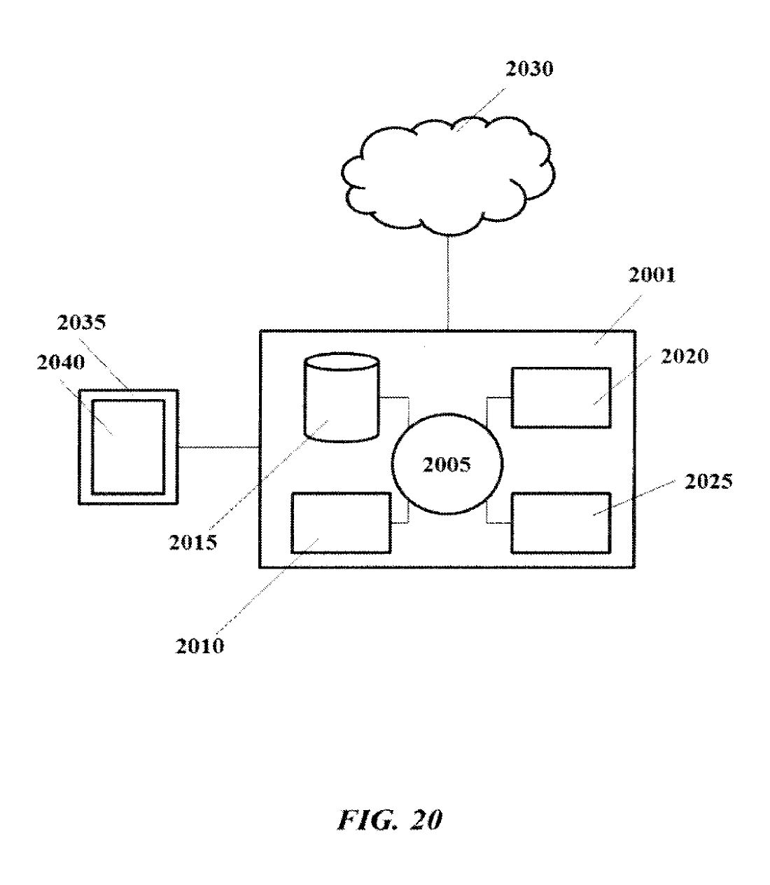

The present disclosure provides computer control systems that are programmed to implement methods of the disclosure. FIG. 20 shows a computer system 2001 that is programmed or otherwise configured to receive and transmit video and audio signals, receive user input, and combine, edit, and share multiple video streams. The computer system 2001 can further regulate various aspects of the system of the present disclosure, such as, for example, adjusting variables of one or more sensors of the system and adjusting variables of one or more light sources of the system. The computer system 2001 can be an electronic device of a user or a computer system that is remotely located with respect to the electronic device. The electronic device can be a mobile electronic device.

The system comprises a computer system 2001 in the base station 100 which may extend out to other devices or areas via cables or wireless connections beyond the base station 100 to perform the programmed functions. The computer system 2001 includes a central processing unit (CPU, also “processor” and “computer processor” herein) 2005, which can be a single core or multi core processor, or a plurality of processors for parallel processing. The computer system 2001 also includes memory or memory location 2010 (e.g., random-access memory, read-only memory, flash memory), electronic storage unit 2015 (e.g., hard disk), communication interface 2020 (e.g., network adapter) for communicating with one or more other systems, and peripheral devices 2025, such as cache, other memory, data storage and/or electronic display adapters. The memory 2010, storage unit 2015, interface 2020 and peripheral devices 2025 are in communication with the CPU 2005 through a communication bus (solid lines), such as a motherboard. The storage unit 2015 can be a data storage unit (or data repository) for storing data. The computer system 2001 can be operatively coupled to a computer network (“network”) 2030 with the aid of the communication interface 2020. The network 2030 can be the Internet, an internet and/or extranet, or an intranet and/or extranet that is in communication with the Internet. The network 2030 in some cases is a telecommunication and/or data network. The network 2030 can include one or more computer servers, which can enable distributed computing, such as cloud computing. The network 2030, in some cases with the aid of the computer system 2001, can implement a peer-to-peer network, which may enable devices coupled to the computer system 2001 to behave as a client or a server.

The CPU 2005 can execute a sequence of machine-readable instructions, which can be embodied in a program or software. The instructions may be stored in a memory location, such as the memory 2010. The instructions can be directed to the CPU 2005, which can subsequently program or otherwise configure the CPU 2005 to implement methods of the present disclosure. Examples of operations performed by the CPU 2005 can include fetch, decode, execute, and writeback.

The CPU 2005 can be part of a circuit, such as an integrated circuit. One or more other components of the system 2001 can be included in the circuit. In some cases, the circuit is an application specific integrated circuit (ASIC).

The storage unit 2015 can store files, such as drivers, libraries and saved programs. The storage unit 2015 can store user data, e.g., user preferences and user programs. The computer system 2001 in some cases can include one or more additional data storage units that are external to the computer system 2001, such as located on a remote server that is in communication with the computer system 2001 through an intranet or the Internet.

The computer system 2001 can communicate with one or more remote computer systems through the network 2030. For instance, the computer system 2001 can communicate with a remote computer system of a user (e.g., streaming audience). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 2001 via the network 2030.

Methods as described herein can be implemented by way of machine (e.g., computer processor) executable code stored on an electronic storage location of the computer system 2001, such as, for example, on the memory 2010 or electronic storage unit 2015. The machine executable or machine readable code can be provided in the form of software. During use, the code can be executed by the processor 2005. In some cases, the code can be retrieved from the storage unit 2015 and stored on the memory 2010 for ready access by the processor 2005. In some situations, the electronic storage unit 2015 can be precluded, and machine-executable instructions are stored on memory 2010.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 2001, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 2001 can include or be in communication with an electronic display 2035 that comprises a user interface (UI) 2040 for providing, for example, system control options, sensor control options, display options, and editing options. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 2005. The algorithm can, for example, run editing sequences or perform video analysis.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A portable multi-view system for combining audio and video streams, comprising:
(a) one or more adjustable arms attached to a base station, each of the one or more arms comprising one or more sensors, including a first camera transmitting a first video signal and a second camera transmitting a second video signal;
(b) a signal processor communicatively coupled to the one or more sensors for receiving, viewing, editing, and transmitting signals from the one or more sensors, including the first video signal and the second video signal; and
(c) an image processing module residing in a memory, communicatively coupled to the signal processor, with instructions for combining the signals received from the one or more sensors, including the first and second video signals, and sharing the combined streams according to real-time user input.

2. The system of claim 1, further comprising one or more displays, one or more memory storage, or one or more online streaming services communicatively coupled to the signal processor from which a user may select to share one or more combined streams.

3. The system of claim 2, wherein the one or more displays include a display of a computing device through which a user is capable of providing real-time user input to the signal processor at the same time the one or more combined streams are received and displayed by the computing device.

4. The system of claim 1, further comprising one or more displays, one or more memory storage, or one or more online streaming services communicatively coupled to the signal processor from which a user may select to share the one or more individual signals received from the one or more sensors.

5. The system of claim 4, wherein the one or more displays include a display of a computing device through which a user is capable of providing real-time user input to the signal processor at the same time the one or more individual signals are received and displayed by the computing device.

6. The system of claim 1, wherein the signal processor is capable of receiving one or more signals from one or more external sensors or one or more memory storage communicatively coupled to the signal processor.

7. The system of claim 1, wherein the image processing module further contains instructions for combining the signals according to pre-programmed editing instructions.

8. The system of claim 7, wherein the signals are combined according to both real-time user input and pre-programmed editing instructions.

9. The system of claim 8, wherein the pre-programmed editing instructions are capable of being triggered by user input.

10. A method for combining and sharing audio and video streams, comprising:
(a) receiving simultaneously one or more video and audio input signals;
(b) receiving real-time user input;
(c) combining said simultaneous signals into one or more combined streams following either or both pre-programmed editing instructions and said real-time user input; and
(d) transmitting said one or more combined streams to one or more memory storage, one or more displays, or one or more online streaming services.

11. The method of claim 10, wherein the video and audio input signals are received from one or more sensors or one or more memory storage.

12. The method of claim 10, wherein the one or more displays include a display of a computing device through which a user is capable of providing the real-time user input at the same time the one or more combined streams are received and displayed by the computing device.

13. The method of claim 10, further comprising transmitting individually the one or more video or audio input signals to one or more memory storage, one or more displays, or one or more online streaming services.

14. The method of claim 13, wherein the one or more displays include a display of a computing device through which a user is capable of providing the real-time user input at the same time the one or more individual video or audio input signals are received and displayed by the computing device.

15. The method of claim 13, wherein a user selects which of the one or more individual video and audio input signals and the one or more edited streams to transmit to which of the one or more memory storage, one or more displays, or one or more online streaming services.

16. The method of claim 10, wherein the pre-programmed editing instructions are triggered by real-time user input.
